(19) United States
(12) Patent Application Publication
(10) Pub. No.: US 2009/0249319 A1
(43) Pub. Date: Oct. 1, 2009

(54) Testing method of baseboard management controller

(75) Inventors: Yuan Bai, Tianjin (CN); Wen-Peng Wang, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/078,120

(22) Filed: Mar. 27, 2008

(51) Int. Cl. G06F 9/44

(52) U.S. Cl. 717/168

(57) ABSTRACT

A testing method of baseboard management controller (BMC) is used for testing firmware stability of a BMC in a server. The testing method includes initializing a plurality of virtual operating systems; setting a plurality of virtual intelligent platform management interfaces (IPMIs) and a virtual BMC in the virtual operating systems; performing a firmware update on the virtual BMC through the virtual IPMI to update the firmware of the virtual BMC; performing a stability test through the virtual BMC and the server; and loading the firmware of the virtual BMC passing the stability test into a physical BMC.

### BACKGROUND OF THE INVENTION

1. Field of Invention

The present invention relates to a testing method of baseboard management controller (BMC). More particularly, the present invention relates to a firmware testing method corresponding to a virtual periphery in a virtual intelligent platform management interface (IPMI).

2. Related Art

Intelligent platform management interface (referred to as IPMI) is provided for a system manager to monitor health status of various components in a computer through the transmission mode of a network or standard serial. For example, the operation of a central processing unit (CPU), rotation speed of a cooling fan, and temperature and voltage of a main board chip are monitored. The system manager may set a sensing critical value for the portion to be monitored, and thus on sensing any abnormity, the IPMI controller will send an email or a simple network management protocol to inform the system manager to handle the problem. Further, through the combination of hardware and software, the IPMI acquires additional functions of remote management and system revert, such that the system manager may learn about the current status of the system (for example, shutting down, booting, or OS crash) and then send a command to shut down, boot, or reboot the system at a remote end.

Referring to FIG. 1, a schematic architectural view of an IPMI and a BMC in the conventional art is shown. The IPMI 120 achieves remote monitor of a remote device 110 through the BMC 130. The BMC 130 periodically polls a digital sensor to monitor the current working status of the remote device 110, and communicates with the host through a system management bus interface. In other words, the BMC 130 may be regarded as an independent computing unit, and thus the BMC 130 must have an independent firmware to drive relevant functions thereof.

Therefore, the BMC 130 may have its firmware updated according to the research and development requirements of the manufacturer. However, as the BMC 130 has certain recordable times, if a physical chip is used in process development and test, the service life of the chip of the BMC 130 will be shortened. Meanwhile, the update operation is very dangerous. Once an undesired file is updated during the test, the computer may not be booted, and the chip of the BMC 130 on the server may even be damaged in a worse situation.

### SUMMARY OF THE INVENTION

Accordingly, the present invention is mainly directed to a testing method of baseboard management controller (BMC) for testing firmware stability of a BMC in a server.

In order to achieve the above objective, a testing method of BMC is provided. The testing method includes: initializing a plurality of virtual operating systems; setting a plurality of virtual intelligent platform management interfaces (IPMIs) and a virtual BMC in the virtual operating systems; performing a firmware update on the virtual BMC through the-virtual IPMI to update the firmware of the virtual BMC; performing a stability test through the virtual BMC and the server; and loading the firmware of the virtual BMC passing the stability test into a physical BMC.

Therefore, the present invention provides a method of updating and testing the stability of a firmware of a BMC in a virtual IPMI, so as to reduce the recording times of the chip of a physical BMC, and prevent the chip of the physical BMC being burnt due to undesired firmware update.

The features and practice of the present invention will be described in detail below in the embodiments with the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a schematic architectural view of a conventional art;

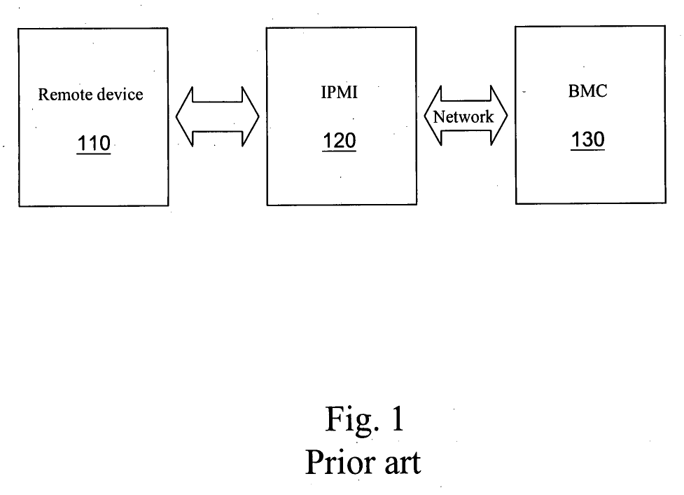

FIG. 2 is a schematic architectural view of the present invention;

FIG. 3 is a schematic view of the operating process of the present invention; and

FIG. 4 is an architectural view of a virtual network card.

### DETAILED DESCRIPTION OF THE INVENTION

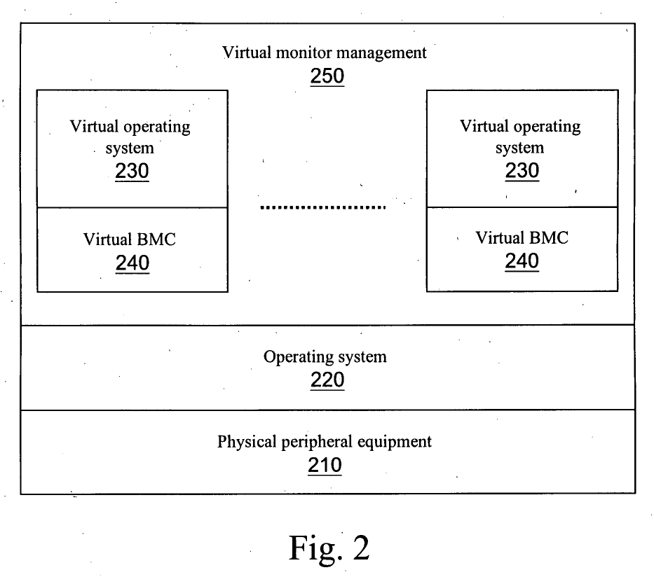

Referring to FIG. 2, a schematic architectural view of the present invention is shown. In FIG. 2, a physical peripheral equipment 210 is at the lower level. The physical peripheral equipment 210 may be, but not limited to, a chassis management control unit, a redundant power supply management unit, an input/output control card, or a local area network (LAN) management unit.

An operating system 220 is constructed above the physical peripheral equipment 210. The operating system 220 may be a Windows operating system from Microsoft Company or an open source code operating system, such as Unix. Virtual operating systems 230 are further constructed above the operating system 220. The virtual operating systems 230 may be implemented by a fully virtualized virtual monitor management 250. The fully virtualized virtual monitor management 250 may be, but not limited to, VMware, VirtualBox, Bochs, or QEM. The fully virtualized virtual monitor management 250 coordinates with the operating system 220 to perform a simulation processing on the physical peripheral equipment 210. The virtual operating systems 230 is initialized in each virtual monitor management 250, and the virtual operating systems 230 may be regarded as a computer simulated in the operating system 220. Each virtual operating systems 230 includes an individual CPU, memory, storage unit, and peripheral equipment.

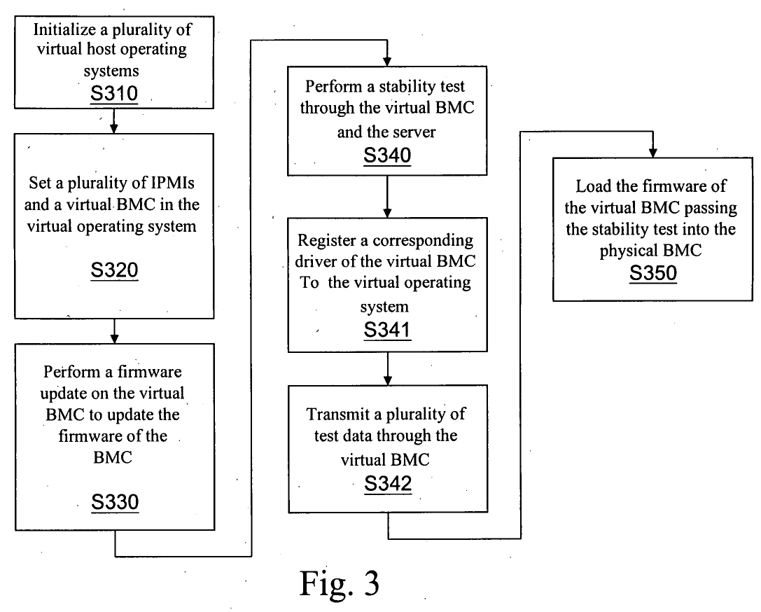

The peripheral equipment of the virtual operating systems 230 includes a virtual BMC 240. Thus, a virtual BMC 240 to be tested by the manufacturer may be added in the virtual operating systems 230. Referring to FIG. 3, a schematic view of the operating process of the present invention is shown. The present invention includes the following steps. A plurality of virtual operating systems is initialized (Step S310). A plurality of IPMIs and a virtual BMC are set in the virtual operating systems (Step S320).

A firmware update is performed on the virtual BMC to update the firmware of the virtual BMC (Step S330). The firmware update is performed through the virtual IPMI.

A stability test is performed through the virtual BMC and the server (Step S340). A corresponding driver of the virtual BMC is registered to the virtual operating systems (Step S341). A plurality of test data is transmitted through the virtual BMC (Step S342). The step is to test the stability of data transmission of the virtual BMC 240. In addition to the physical BMC, the virtual control manager may also transmit test data to virtual BMCs 240 in other virtual operating systems 230.

Each virtual operating systems 230 may be regarded as a computer that operates independently. Therefore, the test data is transmitted to the virtual control manager in each virtual operating systems 230 by the operating system 220 respectively, and a corresponding response data is fed back by the virtual operating systems 230. Then, the operating system 220 compares to see the accuracy of the received response data, so as to determine the operation stability of the virtual control manager of the virtual operating systems 230 after firmware update. Finally, the firmware of the virtual BMC passing the stability test is loaded into the physical BMC (Step S350).

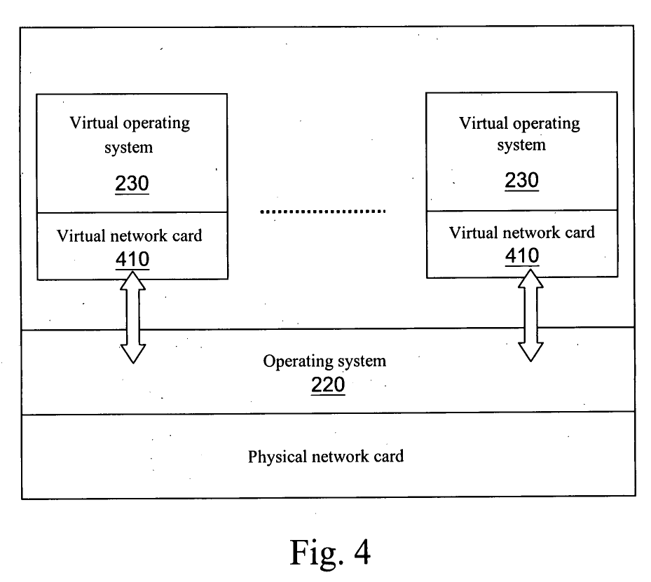

The BMC of a network card is adopted for illustration in this embodiment. Referring to FIG. 4, an architectural view of a virtual network card is shown. First, a virtual operating systems 230 is built. A virtual IPMI and a virtual BMC 240 are added in the virtual operating systems 230. Here, the virtual BMC 240 of a virtual network card 410 and a virtual operating system of Linux are adopted for illustration. The virtual network card 410 transmits a received datagram to a kernel through a push operation. At this time, a driver of the virtual network card 410 needs to be registered into the kernel. The kernel of the Linux has a datagram operating interface particularly designed for the network equipment driver. The subscriber may also configure according to the target operating environment for selectively adding to support various equipments or various document systems and configure leading parameters. When the driver of a new network card equipment is executed in the Linux kernel, configuration support for the new equipment must be added.

Therefore, a firmware update may be performed on the newly added virtual network card 410 in the virtual operating systems 230. The firmware of the virtual network card 410 may be updated through the virtual operating systems 230. After finishing the firmware update, the virtual operating systems 230 will perform a stability test on the virtual network card 410. In particular, the virtual operating systems 230 checks the integrity of packets transmitted between the virtual network card 410 and other network equipments, so as to determine the operation stability of the virtual network card 410. Finally, the firmware of the network card passing the stability test is recorded into a physical network card.

The present invention provides a method of updating and testing the stability of a firmware of the BMC 240 in a virtual IPMI. Finally, the firmware passing the test is installed into a physical BMC, so as to reduce the recording times of the chip of the physical BMC, and prevent the chip of the physical BMC being burnt due to undesired firmware update.

What is claimed is:

1. A testing method of baseboard management controller (BMC), for testing firmware stability of a BMC in a server, the method comprising:
initializing a plurality of virtual operating systems;
setting a plurality of virtual intelligent platform management interfaces (IPMIs) and a virtual BMC in the virtual operating systems;
performing a firmware update on the virtual BMC to update the firmware of the virtual BMC;
performing a stability test through the virtual BMC and the server; and
loading the firmware of the virtual BMC passing the stability test into a physical BMC.

2. The testing method of BMC as claimed in claim 1, wherein the virtual operating systems are initialized by any one of VMware, VirtualBox, Bochs, or QEMU.

3. The testing method of BMC as claimed in claim 1, wherein the virtual BMC is a chassis management control unit, a redundant power supply management unit, an input/output control card, or a local area network (LAN) management unit.

4. The testing method of BMC as claimed in claim 1, wherein the firmware update is performed through the virtual IPMI.

5. The testing method of BMC as claimed in claim 1, wherein the stability test further comprises:
registering a corresponding driver of the virtual BMC to the virtual operating systems; and
transmitting a plurality of test data through the virtual BMC.

6. The testing method of BMC as claimed in claim 5, wherein the test data is transmitted to the physical BMC through the virtual BMC.

7. The testing method of BMC as claimed in claim 5, wherein the test data is transmitted to other virtual BMCs through the virtual BMC.
